(19) United States
(12) Patent Application Publication
(10) Pub. No.: US 2022/0274883 A1
(43) Pub. Date: Sep. 1, 2022

(54) CERAMIC BATCH MIXTURES HAVING DECREASED WALL DRAG

(71) Applicant: CORNING INCORPORATED, CORNING, NY (US)

(72) Inventors: Daniel Edward McCauley, Horseheads, NY (US); Maxime Moreno, Saint Ange Le Vieil (FR); Conor James Walsh, Campbell, NY (US); Stephanie Stoughton Wu, Allston, MA (US)

(21) Appl. No.: 17/745,514

(22) Filed: May 16, 2022

Related U.S. Application Data
(63) Continuation of application No. 16/269,121, filed on Feb. 6, 2019, now abandoned.
Application No. 16/269,121 is a continuation of application No. 14/673,240, filed on Mar. 30, 2015, now abandoned.

(51) Int. Cl. C04B 35/14; C04B 35/185; C04B 35/195; C04B 35/478; C04B 35/565; C04B 35/632; C04B 38/00; C04B 35/10

(52) U.S. Cl. CPC C04B 35/14; C04B 35/185; C04B 35/195; C04B 35/478; C04B 35/565; C04B 35/632; C04B 38/0006; C04B 35/10; C04B 2111/00129

(57) ABSTRACT

According to embodiments, a batch mixture includes inorganic components, a non-polar carbon chain lubricant, and an organic surfactant having a polar head. The non-polar carbon chain lubricant and the organic surfactant are present in concentrations satisfying the relationship: B(C₁(d+d₀)+C₂(f+f₀))=SC, where: d₀+d is an amount of non-polar carbon chain lubricant in percent by weight of the inorganic components, by super addition; f₀+f is an amount of organic surfactant in percent by weight of the inorganic components, by super addition; B is a scaling factor; C₁ is a scaling factor of the concentration of the non-polar carbon chain lubricant; and C₂ is a scaling factor of the concentration of the organic surfactant. Embodiments provide that 3.6≤SC≤14.

### CROSS-REFERENCE TO RELATED APPLICATIONS

This application is a continuation of U.S. patent application Ser. No. 16/269,121 filed on Feb. 6, 2019, which claims the benefit of priority to U.S. patent application Ser. No. 14/673,240 filed on Mar. 30, 2015, the contents of which is relied upon and incorporated herein by reference in its entirety, and the benefit of priority under 35 U.S.C. § 120 is hereby claimed.

### FIELD

The present specification generally relates to ceramic batch mixtures and, more specifically, to ceramic batch mixtures having decreased wall drag which include a non-polar carbon chain lubricant and an organic surfactant having a polar head.

### TECHNICAL BACKGROUND

The process stability of extruding ceramic honeycomb monoliths is dependent on batch flow characteristics of the batch through the manufacturing equipment and extrusion dies. Batch flow characteristics may be determined, at least in part, by the stiffness and wall drag characteristics of the ceramic paste formed from the ceramic batch. The stiffness of the ceramic paste should be such that the extrudate retains its shape after extrusion until it is dried, but also such that the ceramic paste can be deformed through the extrusion die under reasonable pressures.

The wall drag of the ceramic paste should be such that the ceramic paste moves through the manufacturing equipment and the extrusion dies at a reasonable pressure. However, fluids used to lower wall drag should not be added in quantities such that the resultant extrudate loses stiffness or has a decrease in tensile strength.

Accordingly, a need exists for alternative ceramic batch mixtures suitable for extrusion forming processes and that have low wall drag.

### SUMMARY

According to one aspect, a batch mixture for extruding into an extruded body may include an inorganic component, a non-polar carbon chain lubricant, and an organic surfactant having a polar head. The inorganic component is selected from the group consisting of ceramic ingredients, inorganic ceramic-forming ingredients, and combinations thereof. The non-polar carbon chain lubricant and the organic surfactant may be present in concentrations satisfying the relationship:

B[C₁(d+d₀)+C₂(f+f₀)]=SC,

where: d₀ is a minimum amount of the non-polar carbon chain lubricant in percent by weight of the inorganic component, by super addition; d is an additional amount of the non-polar carbon chain lubricant in percent by weight of the inorganic component, by super addition; f₀ is a minimum amount of the organic surfactant in percent by weight of the inorganic component, by super addition; f is an additional amount of the organic surfactant in percent by weight of the inorganic component, by super addition; C₁ is a scaling factor of the concentration of the non-polar carbon chain lubricant; C₂ is a scaling factor of the concentration of the organic surfactant; and B is a scaling factor based on other extrusion factors. In this aspect, 3≤(d+d₀)≤10 and 0.3≤(f+f₀)≤10. Further, in this aspect, 0.5≤C₁≤1.5 and 0.5C₁≤C₂≤4C₁. The variable SC represents the wall slip, and 3.6≤SC≤14.

According to another aspect, a ceramic precursor batch may include inorganic ceramic-forming ingredients, at least one polyalphaolefin, and at least one fatty acid surfactant. The polyalphaolefin and the fatty acid surfactant may be present in concentrations satisfying the relationship:

B[C₁(d+d₀)+C₂(f+f₀)]=SC,

where: d₀ is a minimum amount of the non-polar carbon chain lubricant in percent by weight of the inorganic component, by super addition; d is an additional amount of the non-polar carbon chain lubricant in percent by weight of the inorganic component, by super addition; f₀ is a minimum amount of the organic surfactant in percent by weight of the inorganic component, by super addition; f is an additional amount of the organic surfactant in percent by weight of the inorganic component, by super addition; C₁ is a scaling factor of the concentration of the non-polar carbon chain lubricant; C₂ is a scaling factor of the concentration of the organic surfactant; and B is a scaling factor based on other extrusion factors. In this aspect, 3.5≤(d+d₀)≤10 and 0.7 (f+f₀)≤5. Further, in this aspect, 0.5≤C₁≤1.5 and 0.5C₁≤C₂≤4C₁. The variable SC represents the wall slip, and 3.6≤SC≤14.

According to yet another aspect, a method of making an unfired extruded body is provided. The method may include: adding at least one polyalphaolefin and at least one fatty acid surfactant to one or more ceramic ingredients or inorganic ceramic-forming ingredients; mixing the at least one polyalphaolefin, the at least one fatty acid surfactant, and the one or more ceramic ingredients or inorganic ceramic-forming ingredients to form a batch mixture; and extruding the batch mixture through a forming die to form a green body. The polyalphaolefin and the fatty acid surfactant may be present in concentrations satisfying the relationship:

B[C₁(d+d₀)+C₂(f+f₀)]=SC,

where: d₀ is a minimum amount of the non-polar carbon chain lubricant in percent by weight of the inorganic component, by super addition; d is an additional amount of the non-polar carbon chain lubricant in percent by weight of the inorganic component, by super addition; f₀ is a minimum amount of the organic surfactant in percent by weight of the inorganic component, by super addition; f is an additional amount of the organic surfactant in percent by weight of the inorganic component, by super addition; C₁ is a scaling factor of the concentration of the non-polar carbon chain lubricant; C₂ is a scaling factor of the concentration of the organic surfactant; and B is a scaling factor based on other extrusion factors. In this aspect, 3≤(d+d₀)≤10 and 0.3≤(f+f₀)≤10. Further, in this aspect, 0.5≤C₁≤1.5 and 0.5C₁≤C₂≤4C₁. The variable SC represents the wall slip, and 3.6≤SC≤14.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various aspects and embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 graphically depicts the wall shear stress (y-axis) of an exemplary batch mixture as a function of the velocity (x-axis) of the ceramic paste through an extrusion die;

FIG. 2 graphically depicts the wall shear stress (y-axis) of another exemplary batch mixture as a function of the velocity (x-axis) of the ceramic paste through an extrusion die;

FIG. 3A graphically depicts batch characteristics as with a function of the concentration of polyalphaolefin (y-axis) and tall oil (x-axis) in the batch;

FIG. 3B graphically depicts the effect of different values of the scaling factor C₂ on the relationship of the concentration of non-polar carbon chain lubricant (y-axis) and the concentration of organic surfactant (x-axis);

FIG. 3C graphically depicts the effect of different values of the scaling factor B on the relationship of the concentration of non-polar carbon chain lubricant (y-axis) and the concentration of organic surfactant (x-axis);

FIG. 4 schematically depicts a hypothesis of the interaction by which various embodiments reduce wall drag;

FIG. 5 graphically depicts the wall shear stress (y-axis) of an exemplary batch mixture including 4% polyalphaolefin and 1.5% stearic acid as a function of the velocity (x-axis) of the ceramic paste through the extrusion die;

FIG. 6 graphically depicts the wall shear stress (y-axis) of an exemplary batch mixture including 5.5% polyalphaolefin and 1.5% stearic acid as a function of the velocity (x-axis) of the ceramic paste through the extrusion die;

FIG. 7 graphically depicts the wall shear stress (y-axis) of an exemplary batch mixture including 4% polyalphaolefin and 2% stearic acid as a function of the velocity (x-axis) of the ceramic paste through the extrusion die;

FIG. 8 graphically depicts the wall shear stress (y-axis) of an exemplary batch mixture including 4% polyalphaolefin and 3% stearic acid as a function of the velocity (x-axis) of the ceramic paste through the extrusion die;

FIG. 9 graphically depicts the wall shear stress (y-axis) of an exemplary batch mixture including 4.75% polyalphaolefin and 2% stearic acid as a function of the velocity (x-axis) of the ceramic paste through the extrusion die;

FIG. 10 graphically depicts the wall shear stress (y-axis) of an exemplary batch mixture including 5.5% polyalphaolefin and 2% stearic acid as a function of the velocity (x-axis) of the ceramic paste through the extrusion die;

FIG. 11 graphically depicts the wall shear stress (y-axis) of an exemplary batch mixture including 5.5% polyalphaolefin and 3% stearic acid as a function of the velocity (x-axis) of the ceramic paste through the extrusion die;

FIG. 12 graphically depicts the wall shear stress (y-axis) of exemplary batch mixtures having varying non-polar carbon chain lubricants as a function of the velocity (x-axis) of the ceramic paste through the extrusion die at 10° C.;

FIG. 13 graphically depicts the wall shear stress (y-axis) of exemplary batch mixtures having varying non-polar carbon chain lubricants as a function of the velocity (x-axis) of the ceramic paste through the extrusion die at 18° C.;

FIG. 14 graphically depicts the wall shear stress (y-axis) of exemplary batch mixtures having varying non-polar carbon chain lubricants as a function of the velocity (x-axis) of the ceramic paste through the extrusion die at 26° C.;

FIG. 15 graphically depicts the wall shear stress (y-axis) of exemplary batch mixtures having varying organic surfactants as a function of the velocity (x-axis) of the ceramic paste through the extrusion die at 18° C.;

FIG. 16 graphically depicts the wall shear stress (y-axis) of exemplary batch mixtures having varying organic surfactants as a function of the velocity (x-axis) of the ceramic paste through the extrusion die at 26° C.;

FIG. 17 graphically depicts the wall shear stress (y-axis) of exemplary batch mixtures having varying organic surfactants as a function of the velocity (x-axis) of the ceramic paste through the extrusion die at 34° C.;

FIG. 18 graphically depicts the wall shear stress (y-axis) of exemplary batch mixtures having varying organic surfactants as a function of the velocity (x-axis) of the ceramic paste through the extrusion die at 30° C.; and

FIG. 19 graphically depicts the wall shear stress (y-axis) of exemplary batch mixtures having varying organic surfactants as a function of the velocity (x-axis) of the ceramic paste through the extrusion die at 40° C.

### DETAILED DESCRIPTION

Reference will now be made in detail to various embodiments of ceramic precursor batches and methods of forming green ceramic bodies using the same. Whenever possible, the same reference numerals will be used throughout the drawings to refer to the same or like parts. The components of the batch mixture may generally include inorganic components such as ceramic ingredients or inorganic ceramic-forming ingredients, a non-polar carbon chain lubricant, and an organic surfactant having a polar head. The batch mixture relies upon the presence of a synergistic amount of non-polar carbon chain lubricant and organic surfactant to provide reduced wall drag at various temperatures and extrusion velocities. Accordingly, when the batch mixture is extruded through an extrusion die, it has a low wall drag, which in turn, provides process stability. Various embodiments of batch mixtures and methods of forming unfired extruded bodies using the same will be described with specific reference to the appended drawings.

As used herein, the terms “unfired extruded body,” “green body,” “green ceramic body,” or “ceramic green body” refer to an unsintered body, part, or ware before firing, unless otherwise specified. The terms “batch mixture,” “ceramic precursor batch,” “green composition,” and “green batch material” refer to the mixture of materials that are used to form the green body by extrusion, unless otherwise specified. The unfired extruded body and batch mixture contain a vehicle, such as water, and typically include inorganic components, and can include other materials such as binders, pore formers, stabilizers, plasticizers, and the like. As used herein, “firing” refers to thermal processing of the green body at an elevated temperature to form a ceramic material or a ceramic body.

As used herein, a “wt %,” “weight percent,” or “percent by weight” of an inorganic or organic component, unless specifically stated to the contrary, is based on the total weight of the total inorganics in which the component is included. Organic components are specified herein as super additions based upon 100% of the inorganic components used.

Specific and preferred values disclosed for components, ingredients, additives, reactants, constants, scaling factors, and like aspects, and ranges thereof, are for illustration only. They do not exclude other defined values or other values within defined ranges. The compositions, apparatus, and methods of the disclosure include those having any value or combination of the values, specific values, or ranges thereof described herein.

The batch mixture from which the unfired extruded body is formed includes at least one inorganic component. The inorganic component may be one or more ceramic ingredient, one or more inorganic ceramic-forming ingredient, and/or combinations thereof. The ceramic ingredient may be, for example, cordierite, aluminum titanate, silicon carbide, mullite, alumina, and the like. The inorganic ceramic-forming ingredient may be cordierite-forming raw materials, aluminum titanate-forming raw materials, silicon carbide-forming raw materials, aluminum oxide-forming raw materials, alumina, silica, magnesia, titania, aluminum-containing ingredients, silicon-containing ingredients, titanium-containing ingredients, and the like.

Cordierite has the formula 2MgO.2Al₂O₃.5SiO₂. The cordierite-forming raw materials may include at least one magnesium source, at least one alumina source, at least one silica source, and at least one hydrated clay. In the embodiments described herein, sources of magnesium include, but are not limited to, magnesium oxide or other materials having low water solubility that, when fired, convert to MgO, such as Mg(OH)₂, MgCO₃, and combinations thereof. For example, the source of magnesium may be talc (Mg₃Si₄O₁₀(OH)₂), including calcined and/or uncalcined talc, and coarse and/or fine talc. In various embodiments, the at least one magnesium source may be present in an amount from about 5 wt % to about 25 wt % of the overall cordierite-forming raw materials on an oxide basis. In other embodiments, the at least one magnesium source may be present in an amount from about 10 wt % to about 20 wt % of the cordierite-forming raw materials on an oxide basis. In further embodiments, the at least one magnesium source may be present in an amount from about 11 wt % to about 17 wt %.

Sources of alumina include, but are not limited to, powders that, when heated to a sufficiently high temperature in the absence of other raw materials, will yield substantially pure aluminum oxide. Examples of suitable alumina sources may include alpha-alumina, a transition alumina such as gamma-alumina or rho-alumina, hydrated alumina or aluminum trihydrate, gibbsite, corundum (Al₂O₃), boehmite (AlO(OH)), pseudoboehmite, aluminum hydroxide (Al(OH)₃), aluminum oxyhydroxide, and mixtures thereof. In one embodiment, the at least one alumina source is a kaolin clay, and in another embodiment, the at least one alumina source is not a kaolin clay. The at least one alumina source may be present in an amount from about 25 wt % to about 45 wt % of the overall cordierite-forming raw materials on an oxide basis, for example. In another embodiment, the at least one alumina source may be present in an amount from about 30 wt % to about 40 wt % of the cordierite-forming raw materials on an oxide basis. In a further embodiment, the at least one alumina source may be present in an amount from about 32 wt % to about 38 wt % of the cordierite-forming raw materials on an oxide basis.

Silica may be present in its pure chemical state, such as α-quartz or fused silica. Sources of silica may include, but are not limited to, non-crystalline silica, such as fused silica or sol-gel silica, silicone resin, low-alumina substantially alkali-free zeolite, diatomaceous silica, kaolin, and crystalline silica, such as quartz or cristobalite. Additionally, the sources of silica may further include, but are not limited to, silica-forming sources that comprise a compound that forms free silica when heated. For example, silicic acid or a silicon organometallic compound may form free silica when heated. The at least one silica source may be present in an amount from about 40 wt % to about 60 wt % of the overall cordierite-forming raw materials on an oxide basis. In some embodiments, the at least one silica source may be present in an amount from about 45 wt % to about 55 wt % of the cordierite-forming raw materials on an oxide basis. In a further embodiment, the at least one silica source may be present in an amount from about 48 wt % to about 54 wt %.

Hydrated clays used in cordierite-forming raw materials can include, by way of example and not limitation, kaolinite (Al₂(Si₂O₅)(OH)₄), halloysite (Al₂(Si₂O₅)(OH)₄.H₂O), pyrophylilite (Al₂(Si₂O₅)(OH)₂), combinations or mixtures thereof, and the like. In some embodiments, the at least one alumina source and at least one silica source are not kaolin clays. In other embodiments, kaolin clays, raw and calcined, may comprise less than 30 wt % or less than 20 wt %, of the cordierite-forming raw materials. The green body may also include impurities, such as, for example, CaO, K₂O, Na₂O, and Fe₂O₃.

In some embodiments, the cordierite-forming raw materials have an overall composition comprising, in weight percent on an oxide basis, 5-25 wt % MgO, 40-60 wt % SiO₂, and 25-45 wt % Al₂O₃. In other embodiments, the cordierite-forming raw materials have an overall composition comprising, in weight percent on an oxide basis, 11-17 wt % MgO, 48-54 wt % SiO₂, and 32-38 wt % Al₂O₃.

In embodiments in which the inorganic ceramic-forming ingredients form an aluminum titanate ceramic, the inorganic ceramic-forming ingredients can include an alumina source, a silica source, and a titania source. The titania source can in one aspect be a titanium dioxide composition, such as rutile titania, anatase titania, or a combination thereof. The alumina source and silica source may be selected from the sources of alumina and silica described hereinabove. The amounts of the inorganic ceramic-forming ingredients are suitable to provide a sintered phase aluminum titanate ceramic composition comprising, as characterized in an oxide weight percent basis, from about 8 to about 15 wt % SiO₂, from about 45 to about 53 wt % Al₂O₃, and from about 27 to about 33 wt % TiO₂. For example, an exemplary inorganic aluminum titanate precursor powder batch composition can include approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; 7,001,861; and 7,294,164, each of which is hereby incorporated by reference.

In embodiments in which the inorganic components form a silicon carbide ceramic, the inorganic ceramic-forming ingredients can include about 10-40%, by weight of the final batch, finely powdered silicon metal, preferably about 15-30%. The silicon powder should exhibit a small mean particle size, e.g., from about 0.2 micron to 50 microns, preferably 1-30 microns. The surface area of the silicon powder may, in some instances, be more descriptive than particle size, and should range between about 0.5 to 10 m²/g, preferably between about 1.0-5.0 m²/g. In various embodiments, the silicon powder is a crystalline silicon powder.

The silicon carbide ceramic-forming batch mixture also contains about 10-40%, by weight, of a carbon precursor, for example, a water soluble crosslinking thermoset resin having a viscosity of less than about 1000 centipoise (cp). The thermoset resin utilized may be a high carbon yield resin in an amount such that the resultant carbon to silicon ratio in the batch mixture is about 12:28 by weight, the stoichiometric ratio of Si—C needed for formation of silicon carbide.

Powdered silicon-containing fillers, in an amount up to 60%, by weight, may also be included in the silicon carbide ceramic-forming batch mixture. The main function of these fillers is to prevent excessive shrinkage of the green body during the carbonization and reactive consolidation/sintering steps. Suitable silicon-containing fillers include silicon carbide, silicon nitride, mullite or other refractory materials. Additional exemplary non-limiting inorganic batch component mixtures suitable for forming silicon carbide include those disclosed in U.S. Pat. Nos. 6,555,031 and 6,699,429, each of which is hereby incorporated by reference.

In embodiments in which the inorganic components form an aluminum oxide ceramic, the inorganic components can include Al₂O₃ and/or aluminum oxide-forming ingredients.

In addition to the inorganic components, each of the batch compositions includes an organics package that includes at least a non-polar carbon chain lubricant and an organic surfactant having a polar head. In various embodiments, the organics package also includes one or more binders, and/or one or more pore-forming materials. The term “organics package,” as used herein, excludes the amount of solvents, such as water, included in various batch compositions. The organics package is used to form a flowable dispersion that has a relatively high loading of the ceramic material. The non-polar carbon chain lubricant and the organic surfactant are chemically compatible with the inorganic components, and provide sufficient strength and stiffness to allow handling of the unfired extruded body. Additionally, the organics package is removable from the unfired extruded body during firing without distorting or breaking the ceramic body. In embodiments, the batch mixtures may have an organics package in percent by weight of the inorganic components, by super addition, from about 1% to about 25% or from about 2% to about 20%. In some embodiments, the batch mixture may have an organics package in percent by weight of the inorganic components, by super addition, from about 5% to about 15%, from about 7% to about 12%, or even from about 9% to about 10%. In some embodiments, the batch mixture may have an organics package in percent by weight of the inorganic components, by super addition, from about 5% to about 11%, or about 7%.

The organics package, in some embodiments, may include a binder and at least one pore-forming material. Binders may include, but are not limited to, cellulose-containing components such as methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives, such as hydroxypropyl methylcellulose, are especially suited as organic binders.

Pore-forming materials can include, for example, a starch (e.g., corn, barley, bean, potato, rice, tapioca, pea, sago palm, wheat, canna, and walnut shell flour), polymers (e.g., polybutylene, polymethylpentene, polyethylene (preferably beads), polypropylene (preferably beads), polystyrene, polyamides (nylons), epoxies, ABS, acrylics, and polyesters (PET)), hydrogen peroxides, and/or resins, such as phenol resin. In some embodiments, the organic material may comprise at least one pore-forming material. In other embodiments, the organic material may comprise at least two pore-forming materials. In further embodiments, the organic material may comprise at least three pore-forming materials. For example, in embodiments, a combination of a polymer and a starch may be used as the pore former.

The non-polar carbon chain lubricant provides fluidity to the ceramic precursor batch and aids in shaping the ceramic precursor batch while also allowing the batch to remain sufficiently stiff during the forming (i.e., the extruding) process. The non-polar carbon chain lubricant can include, for example, mineral oils distilled from petroleum, synthetic and semi-synthetic base oils, including Group II and Group III paraffinic base oils, polyalphaolefins, alphaolefins, and the like.

In various embodiments, the non-polar carbon chain lubricant is a polyalphaolefin. Exemplary polyalphaolefins suitable for use include those sold under the trade name DURASYN®, including but not limited to DURASYN® 162 and DURASYN® 164, and SILKFLO®, including but not limited to SILKFLO® 362, available from INEOS Group AG (Switzerland). Other exemplary lubricants suitable for use include those sold under the trade names NEXBASE®, including but not limited to NEXBASE® 3020 (Neste Oil, Finland), and PARAFLEX™, including but not limited to PARAFLEX™ HT5 (Petro-Canada, Canada). In various embodiments, the non-polar carbon chain lubricant is present in an amount of at least 3 wt % of the inorganic components, by super addition.

Organic surfactants having a polar head adsorb to the inorganic particles, keeping the inorganic particles in suspension, preventing clumping, and may generate migration pathways, as described in greater detail hereinbelow. The organic surfactant can include, for example, C₈-C₂₂ fatty acids and/or their ester or alcohol derivatives, such as stearic, lauric, linoleic, oleic, myristic, palmitic, and palmitoleic acids, soy lecithin, and mixtures thereof. In various embodiments, the organic surfactant is present in an amount of at least 0.3 wt % of the inorganic components, by super addition.

In various embodiments, solvents may be added to the batch mixture to create a ceramic paste (precursor or otherwise) from which the unfired extruded body is formed. In embodiments, the solvents may include aqueous-based solvents, such as water or water-miscible solvents. In some embodiments, the solvent is water. The amount of aqueous solvent present in the ceramic precursor batch may range from about 20 wt % to about 50 wt %.

According to various embodiments, a method of making a ceramic body includes adding the organics package (including at least a non-polar carbon chain lubricant and an organic surfactant) to at least one inorganic component. The inorganic components and organic materials may be mixed to form a batch mixture. The batch mixture may be made by conventional techniques. By way of example, the inorganic components may be combined as powdered materials and intimately mixed to form a substantially homogeneous batch. The organic materials and/or solvent may be mixed with inorganic components individually, in any order, or together to form a substantially homogeneous batch. Of course, other suitable steps and conditions for combining and/or mixing inorganic components and organic materials together to produce a substantially homogeneous batch may be used. For example, the inorganic components and organic materials may be mixed by a kneading process to form a substantially homogeneous batch mixture.

In various embodiments, the batch mixture is shaped or formed into a structure using conventional forming means, such as molding, pressing, casting, extrusion, and the like. According to various embodiments, the batch mixture is extruded to form a green body. Extrusion can be achieved using a hydraulic ram extrusion press, a two stage de-airing single auger extruder, or a twin screw mixer with a die assembly attached to the discharge end of the extruder. The batch mixture may be extruded at a predetermined temperature and velocity. According to various embodiments, the temperature and velocity of extrusion are selected such that the wall drag remains relatively low during extrusion, as will be described in greater detail herein.

In various embodiments, the batch mixture is formed into a honeycomb structure. The honeycomb structure may include a web structure having a plurality of cells separated by cell walls. In some embodiments, each of the cell walls has a thickness of less than about 0.005 inch. Such thin-walled honeycomb structures may be susceptible to distortion resulting from, among other things, differential shear or flow of the batch mixture through the extrusion die and/or interactions between the extrusion die and the batch materials.

After formation, the unfired extruded body is then fired at a selected temperature under suitable atmosphere and for a time dependent upon the composition, size, and geometry of the green body to result in a fired, porous ceramic body. Firing times and temperatures depend on factors such as the composition and amount of material in the green body and the type of equipment used to fire the green body. Firing temperatures for forming cordierite may range from about 1300° C. up to about 1450° C., with holding times at the peak temperatures ranging from about 1 hour to about 8 hours and total firing times that may range from about 20 hours up to about 85 hours. Suitable firing processes may include those described in U.S. Pat. Nos. 8,187,525, 6,287,509, 6,099,793, or U.S. Pat. No. 6,537,481, each of which is incorporated by reference in its entirety. When fired to form a ceramic body, the honeycomb structures can be used as particulate filters in internal combustion systems, for example.

Batch flow characteristics may be determined, at least in part, by the stiffness and wall drag characteristics of the ceramic paste formed from the batch. The wall drag of the ceramic paste should be low enough that the ceramic paste moves through the manufacturing equipment and the extrusion dies at a reasonable pressure and with an even flow through the die. However, fluids used to lower wall drag should not be added in quantities such that the resultant extrudate loses stiffness (e.g., slumps) or has a decrease in tensile strength. In the embodiments described herein, the organics package of the batch mixture is controlled to minimize wall drag while preventing slumping, retaining tensile strength, and reducing the pressure used for extrusion. The decreased wall drag can provide product and quality benefits, process benefits, and reductions in manufacturing costs. For example, the ability to alter the wall drag for a batch mixture may minimize bow and reduce slump, while increasing die life and reducing energy costs. Accordingly, the batch mixtures of the various embodiments include concentrations of the non-polar carbon chain lubricant and the organic surfactant sufficient to reduce wall drag while maintaining good tensile strength and maintaining good firing characteristics.

The composition of the batch mixture can also affect the flow of the batch through the extruder. For example, the flow of the composition of the batch mixture may be influenced by the type of binder, the particle sizes and orientation or particles contained in the batch, and the like. In addition, it has been found that the flow of the batch is affected by the amount of non-polar carbon chain lubricant and the amount of organic surfactant having a polar head contained within the batch.

In various embodiments, by modifying the Benbow-Bridgwater equation, the total pressure of the system can be represented according to the relationship:

$${P}_{t o t a l} = ( f {τ}_{y} + g {k ( \frac{V}{d} )}^{n} ) + \frac{4 L}{d} [ β {V}^{m} ]$$

where Ty is the yield stress; k is a consistency index; Vis the extrudate velocity at the wall; d is the capillary diameter; L is the capillary length; β is a wall drag, or slip, coefficient; m is a wall drag power law index; and f and g are geometry terms. The pressure at the wall, P_{w} can be represented according to the relationship:

$${P}_{w} = \frac{4 L}{d} [ β {V}^{m} ]$$

and wall shear stress, T_{w} can be represented according to the relationship:

τ_{w}=βV^{m}.

Thus, wall drag, β, can be represented according to the relationship:

$$β = \frac{log {τ}_{w}}{log V} .$$

In various embodiments, the amount of non-polar carbon chain lubricant and the amount of organic surfactant having a polar head contained within the batch are selected such that the R value is less than about 8.

In the embodiments described herein, wall drag may be measured using a “rate sweep test” in which a batch mixture is simultaneously extruded through two dies in a capillary rheometer. According to various embodiments, both dies have a 1 mm circular opening. However, the first die may have a 0.25 mm length and the second die may have a 16 mm length such that the difference in pressure between the two dies can be attributed to wall drag.

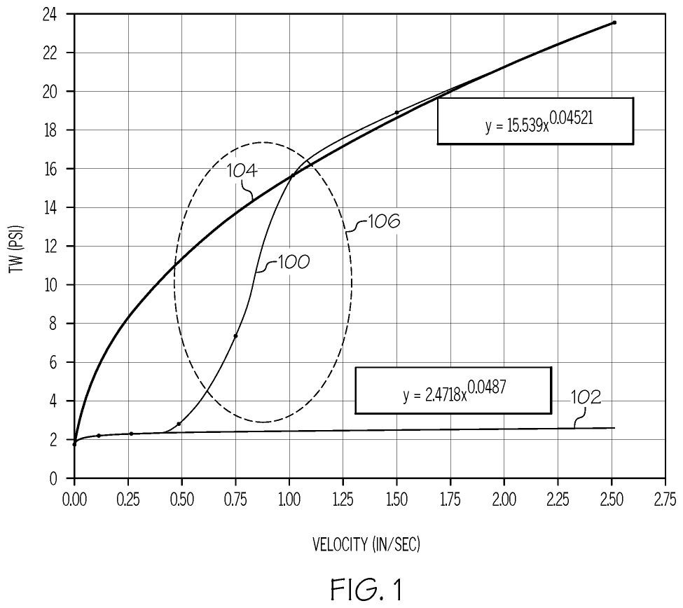

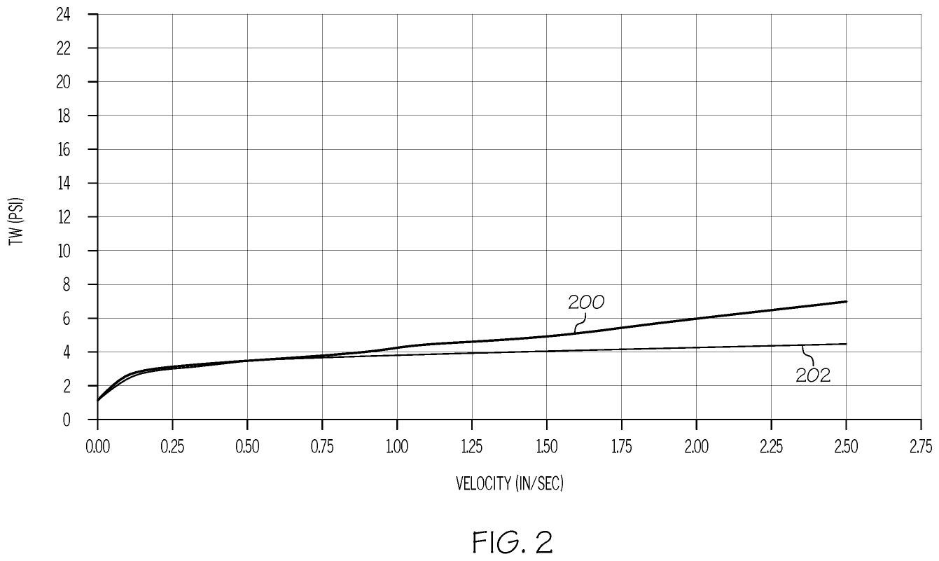

In various embodiments of the rate sweep test, wall drag, or pressure, is measured at a plurality of batch velocities and temperatures and the differences between the pressures on the 0.25 mm die and the 16 mm die are plotted as a function of batch velocity, as shown in FIGS. 1 and 2. In various embodiments, the capillary rheometer is set to a desired temperature, and the batch is extruded at a series of velocities from 0.01 in/s to 4 in/s, corresponding to batch velocities that occur during the extrusion process. The batch velocities are changed after a time period of about 3 minutes to enable the batch to reach a steady state. Batch velocities can be changed, for example, using a programming unit that controls the speed with which the extrusion piston is pushed. The time between velocity changes can vary depending on the particular embodiment, but should be long enough to allow the pressure to stabilize following the change in velocity. After the pressure is measured at each of the desired batch velocities, the temperature is changed and the test is run again to determine the wall drag response to temperature for the batch.

FIG. 1 is a plot of wall shear stress T_{w} as a function of the exit velocity v of the extrudate from a capillary die having a 1 mm diameter for a batch mixture including 0.7% stearic acid and 6% polyalphaolefin. As shown in FIG. 1, the wall shear stress T_{w} varies with respect to extrusion velocity for a given batch mixture. In particular, FIG. 1 illustrates a rheology curve having relatively low wall drag for velocities less than about 0.50 in/s and relatively high wall drag for velocities greater than about 0.75 in/s.

In FIG. 1, curve 100 corresponds to a rate sweep test conducted over velocities from about 0.01 in/s to about 2.5 in/s. As shown in FIG. 1, the curve 100 can be fit to power laws for both low wall drag (curve 102) and high wall drag (curve 104), as will be explained below. Curve 100 exhibits a “wall drag cliff” 106 at velocities between about 0.5 in/s and about 1.0 in/s. As used herein, the wall drag cliff corresponds to the transition of the curve 100 from a low beta power law fit to a high beta power law fit. For velocities to the left of the wall drag cliff, the wall shear stress T_{w} can be derived from the low wall drag power law, while for velocities to the right of the wall drag cliff, the wall shear stress T_{w} can be derived from the high wall drag power law. By fitting the curve 100 with different power laws, beta values can be extracted, for example, using the equations provided hereinabove, to further determine the wall drag of a batch at particular temperatures and velocities.

In contrast, FIG. 2 includes a curve 200 that corresponds to a rate sweep test conducted at about 17° C. and a curve 202 that corresponds to a rate sweep test conducted at about 38° C. for a batch mixture according to the embodiments described herein. As shown in FIG. 2, curves 200 and 202 do not exhibit wall drag cliffs for velocities of up to 2.5 in/s, and the measured wall drag remains below about 8 psi, and the beta values less than about 8 over the range of velocities shown at both temperatures, indicating that the batch mixture has a relatively low wall drag over the range of velocities tested. Accordingly, the batch mixture may result in a green body having less distortion, may require lower extrusion pressures, and may result in energy savings as compared to conventional batch mixtures when used to form extruded green bodies, as described herein.

It has been found that the amounts of the non-polar carbon chain lubricant and the organic surfactant included in the batch mixture can be modified to control the wall drag over a desired range of velocities and temperatures. For example, the amount of the non-polar carbon chain lubricant and the organic surfactant in a batch mixture can be selected such that the batch mixture has low wall drag over the range of velocities and temperatures desired for manufacturing a particular ceramic body.

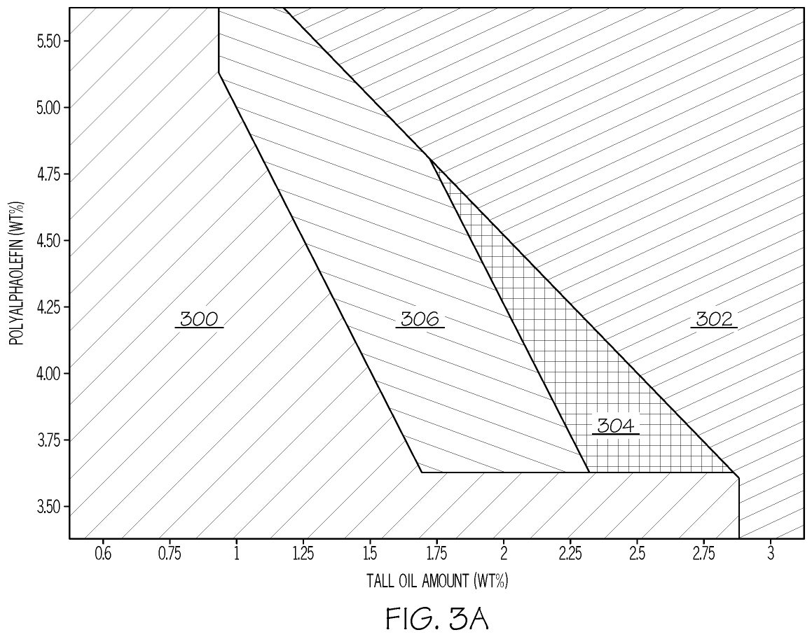

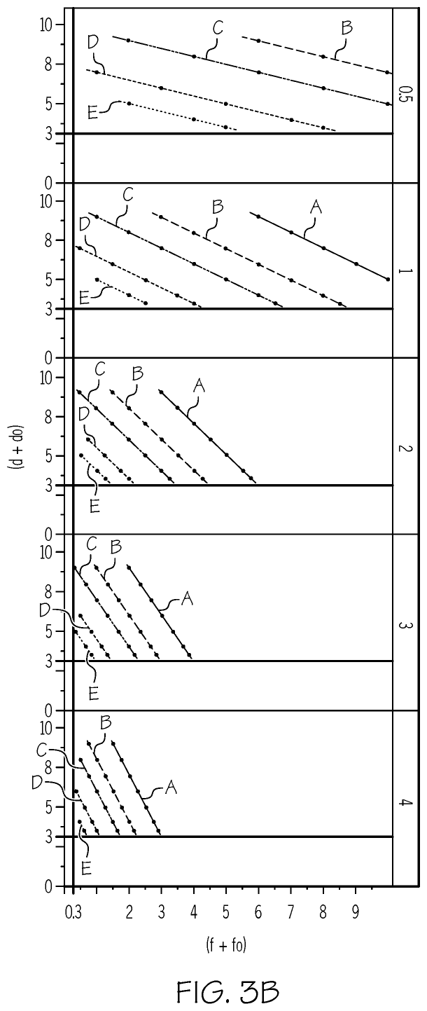

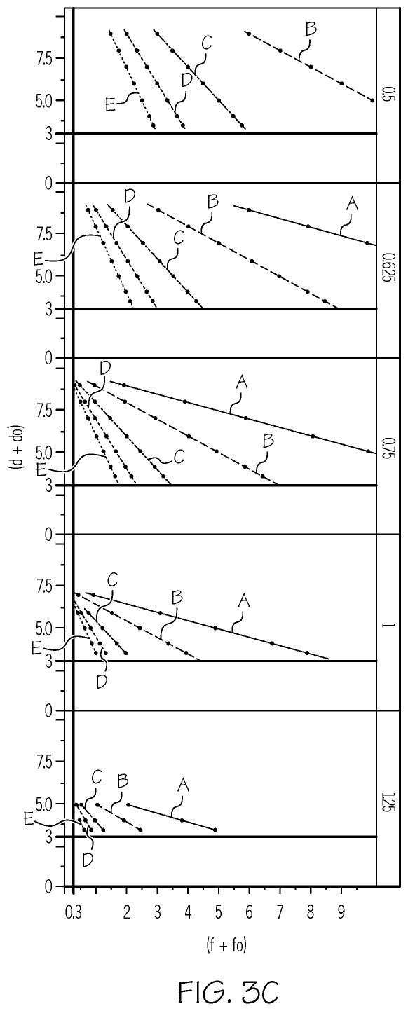

FIG. 3A is a graph summarizing the effect of the concentration of a non-polar carbon chain lubricant (represented on the y-axis) and the concentration of an organic surfactant (represented on the x-axis) on the rheology of batch mixtures according to various embodiments. The non-polar carbon chain lubricant can be, for example, polyalphaolefin, and the organic surfactant can be, for example, tall oil. As shown in FIG. 3A, combinations of non-polar carbon chain lubricant and organic surfactant within area 300 results in high wall drag, while combinations of non-polar carbon chain lubricant and organic surfactant within area 302 results in negative forming effects on the batch, such as insufficient stiffness, making it unsuitable for firing. Additionally, concentrations of lubricant in combination with concentrations of surfactant in area 304 yield an unfired extruded body with poor tensile strength. However, it has now been found that combinations of non-polar carbon chain lubricant and organic surfactant lying within area 306 yield a ceramic batch with suitably low wall drag in combination with other suitable forming characteristics, such as stiffness, tensile strength, and firing characteristics, and which can be used to effectively form a green ceramic body by extrusion.

In various embodiments, “low wall drag” corresponds to beta values of less than about 8 for a power law fit to a corresponding pressure curve for the batch. In various embodiments, “low wall drag” is a measured wall drag of less than about 10 psi. In some embodiments, the wall drag may be less than about 8 psi. In some other embodiments, the wall drag may be less than about 6 psi, or even less than about 4 psi. According to some embodiments, the amount of non-polar carbon chain lubricant and the amount of organic surfactant in a batch mixture are selected such that the batch mixture has a measured wall shear stress of less than about 10 psi over the range of velocities from about 0.1 in/s to about 2.5 in/s at temperatures between about 10° C. and about 45° C. In some embodiments, the amount of non-polar carbon chain lubricant and the amount of organic surfactant in a batch mixture are selected such that the batch mixture has a measured wall shear stress of less than about 8 psi over the range of velocities from about 0.1 in/s to about 2.5 in/s at temperatures between about 24° C. and about 45° C. In still other embodiments, the amount of non-polar carbon chain lubricant and the amount of organic surfactant in a batch mixture is selected such that the batch mixture has a measured wall shear stress of less than about 6 psi over the range of velocities from about 0.1 in/s to about 2.5 in/s at temperatures between about 31° C. and about 45° C. Some embodiments provide that the amount of non-polar carbon chain lubricant and the amount of organic surfactant in a batch mixture is selected such that the batch mixture has a measured wall shear stress of less than about 6 psi over the range of velocities from about 0.1 in/s to about 2.5 in/s at temperatures between about 24° C. and about 45° C. or less than about 4 psi over the range of velocities from about 0.1 in/s to about 2.5 in/s at temperatures between about 24° C. and about 45° C.

According to various embodiments, the non-polar carbon chain lubricant and the organic surfactant are present in the batch mixture in concentrations satisfying the relationship:

B[C₁(d+d₀)+C₂(f+f₀)]=SC,

where: d₀ is a minimum amount of the non-polar carbon chain lubricant in percent by weight of the inorganic component, by super addition; d is an additional amount of the non-polar carbon chain lubricant in percent by weight of the inorganic component, by super addition; f₀ is a minimum amount of the organic surfactant in percent by weight of the inorganic component, by super addition; f is an additional amount of the organic surfactant in percent by weight of the inorganic component, by super addition; C₁ is a scaling factor of the concentration of the non-polar carbon chain lubricant; C₂ is a scaling factor of the concentration of the organic surfactant; and B is a scaling factor based on other extrusion factors.

In various embodiments, the non-polar carbon chain lubricant is present in a concentration such that 3≤(d+d₀)≤10. However, in some embodiments, 3≤(d+d₀)≤5.5. In some embodiments, 3.5≤(d+d₀)≤6. In other embodiments, 4≤(d+d₀)≤5.5. In still other embodiments, 4.75≤(d+d₀)≤5.5. Various embodiments provide that d₀ is equal to about 3.

In various embodiments, the organic surfactant is present in a concentration such that 0.3≤(f+f₀)≤10. However, in some embodiments, 0.3≤(f+f₀)≤3. In other embodiments, 1≤(f+f₀)≤2.5. In other embodiments, 1≤(f+f₀)≤3. In still other embodiments, 1.5≤(f+f₀)≤3. According to other embodiments, 1.75≤(f+f₀)≤2.5. In some embodiments, 1.0≤(f+f₀)≤2.0. In still other embodiments, 0.4≤(f+f₀)≤0.7. Various embodiments provide that f₀ is equal to about 0.3.

In the embodiments described herein the scaling factors C₁ and C₂ are such that 0.5≤C₁≤1.5 and 0.5C₁≤C₂≤4C₁. According to some embodiments, C₁ is equal to about 1 and C₂ is equal to about 2. In other embodiments, C₁ may be equal to about 0.5, 0.75, 1.25, or 1.5. In some embodiments, C₂ may be equal to about 0.5, 1, 1.5, 1.75, 2, 2.25, 2.5, 3, 3.5, or 4.

The variable B can vary depending on the particular embodiment, and accounts for other factors in the extrusion process that may affect wall slip. For example, B may vary depending on inorganic properties, mixing energy, surface finish, or the like. In various embodiments, 0.4≤B≤2. In some embodiments, B is equal to about 0.5, 0.625, 0.75, 1, or 1.25.

The variable SC represents the wall slip, and in various embodiments, 3.6≤SC≤14. In some embodiments, 5.5≤SC≤9.5. In some embodiments, 6.5≤SC≤8.5. In some embodiments, 7≤SC≤11.5. According to some embodiments, SC is equal to about 7. In other embodiments, SC may be equal to about 5, 6, 6.5, 7.5, 8, 8.5, 9, 10, 10.5, 11, 11.5, or 12.

While the values for the variables in these equations may vary depending on the particular embodiment, the batch mixtures of the various embodiments include concentrations of the non-polar carbon chain lubricant and the organic surfactant sufficient to reduce wall drag while maintaining good tensile strength and maintaining good firing characteristics in the ceramic batch.

It should be understood that the particular concentrations of non-polar carbon chain lubricant and organic surfactant sufficient to achieve the desired level of wall drag at a given temperature and velocity may vary within the above-recited ranges depending on other factors. These factors include the particle size distribution, amount of water, inorganic surface chemistry, other organic components present in the batch, the amount of work imparted to the batch mixture (such as during mixing), raw material grade, and the like. For example, decreasing the particle size distribution may move the wall drag cliff to the right of the graph, while increasing the mixing energy moves the wall drag cliff to the left of the graph. In various embodiments, the concentrations of non-polar carbon chain lubricant and/or organic surfactant can be adjusted to yield a desired wall drag response for various extrusion dies, lines, and/or facilities as well as for various inorganic ceramic-forming ingredients in the batch. As an example, the values of B may be closer to the top of the ranges recited above where a high amount of mixing energy is imparted to the batch mixture or where larger particles are present in the batch mixture and may be closer to the lower end of the ranges recited above where fine alumina particles are removed or less mixing energy is imparted to the batch mixture.

As an example, FIGS. 3B and 3C are plots of the concentration of non-polar carbon chain lubricant (y-axis) as a function of the concentration of organic surfactant (x-axis) for an SC of 7.5. FIG. 3B and FIG. 3C demonstrate the power of the organic surfactant, as represented by both C₂ and B. As used herein, the “power” of a surfactant refers to the ionic strength of a surfactant. A surfactant with a higher power is a surfactant having a stronger ionic charge, which in turn corresponds to an increased ability to disperse particles within the batch mixture and maintain the dispered nature of the batch. In FIG. 3B, the scaling factor B has the values of 0.5 (corresponding to line A), 0.625 (corresponding to line B), 0.75 (corresponding to line C), 1 (corresponding to line D), and 1.25 (corresponding to line E). From top to bottom, the scaling factor C₂ has values of 0.5, 1, 2, 3, and 4. As shown in FIG. 3B, as the scaling factor C₂ increases (i.e. a stronger fatty acid is used), the lines get closer together and the slope of each of the lines increases (i.e., the lines become more vertical). In other words, a stronger organic surfactant crowds the lines together (less of the organic surfactant is needed) while a weaker organic surfactant spreads the lines apart (more organic surfactant is needed to achieve the same result). In FIG. 3C, the scaling factor C₂ has values of 0.5 (corresponding to line A), 1 (corresponding to line B), 2 (corresponding to line C), 3 (corresponding to line D), and 4 (corresponding to line E). From top to bottom, the scaling factor B has values of 0.5, 0.625, 0.75, 1, and 1.25. As shown in FIG. 3C, as the scaling factor B increases (again representing a strong organic surfactant), the lines get closer together, but the slope of each of the lines decreases (i.e., the lines become more horizontal).

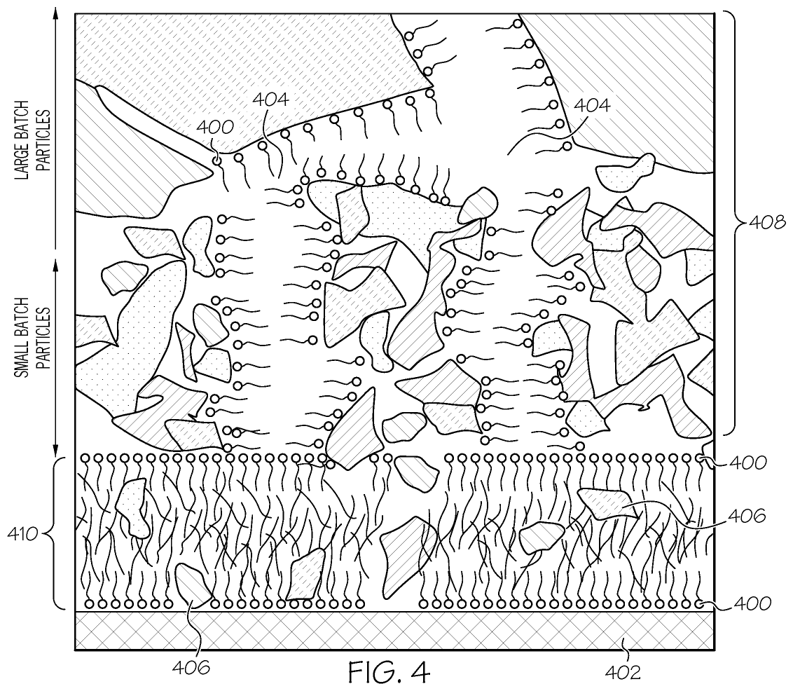

Referring now to FIG. 4, without being bound by theory, it is believed that by selecting the appropriate amount of surfactant and lubricant, the polar heads of the organic surfactant 400 keep the batch apart from both itself and the surfaces upon which the batch is traveling, such as a metal surface 402 (e.g., the surfaces of the extrusion die), as shown in FIG. 4. The organic surfactant 400 thus forms “channels” 404 through which the non-polar carbon chain lubricant 406 and other oils travel from the interior of the batch 408 to the metal surface 402, where a lubrication layer 410 is formed. The transition from high wall drag to low wall drag is a tipping point at which the non-polar carbon chain lubricant 406 readily reaches the surface 402 at a rate which exceeds the rate at which the non-polar carbon chain lubricant 406 is stripped away by the extrusion process. In other words, the wall drag cliff represents a threshold velocity at which there is a transition from a stable lubrication layer (e.g., low wall drag) to an unstable lubrication layer (e.g., high wall drag).

According to various embodiments, a method of making an unfired extruded body includes adding the organics package (including at least a non-polar carbon chain lubricant and an organic surfactant) to inorganic components (e.g., one or more ceramic ingredients and/or the inorganic ceramic-forming ingredients), mixing the ingredients to form a batch mixture, and extruding the batch mixture through a forming die to form a green body.

### EXAMPLES

It is believed that the various embodiments described hereinabove will be further clarified by the following examples.

### Example 1

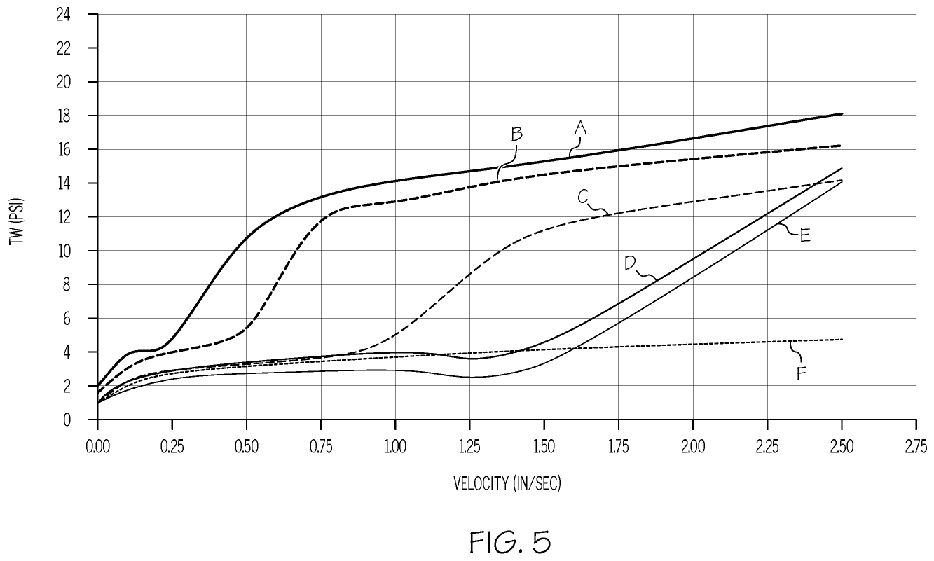

A series of seven batch mixtures having different concentrations of polyalphaolefin and stearic acid were prepared and tested using the sweep rate test described above. Each batch mixture included the same inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package. The organics package for each of the batch mixtures are summarized in Table 1. Wall shear stress was measured for velocities ranging from 0.01 in/s to 2.5 in/s and at temperatures of 10° C. (represented by curve A), 17° C. (represented by curve B), 24° C. (represented by curve C), 31° C. (represented by curve D), 38° C. (represented by curve E), and 45° C. (represented by curve F) for each batch mixture. The concentration of polyalphaolefin was between 4% and 5.5% and the concentration of stearic acid was between 1.5% and 3%. The results are shown in FIGS. 5-11.

TABLE 1
Batch Compositions, expressed in wt %

| | Sample 1 | Sample 2 | Sample 3 | Sample 4 | Sample 5 | Sample 6 | Sample 7 |
|---|---|---|---|---|---|---|---|
| Polyalphaolefin | 4 | 5.5 | 4 | 4 | 4.75 | 5.5 | 5.5 |
| Stearic Acid | 1.5 | 1.5 | 2 | 3 | 2 | 2 | 3 |
| C₁ | 1 | 1 | 1 | 1 | 1 | 1 | 1 |
| C₂ | 2 | 2 | 2 | 2 | 2 | 2 | 2 |
| B | 1 | 1 | 1 | 1 | 1 | 1 | 1 |
| SC | 7 | 8.5 | 8 | 10 | 8.75 | 9.5 | 11.5 |

In particular, FIG. 5 is a plot of wall shear stress T_{w} as a function of the exit velocity v of the extrudate from a capillary die having a 1 mm diameter for a ceramic precursor batch having polyalphaolefin in a concentration of 4% and stearic acid in a concentration of 1.5% (sample 1). Although the batch mixture has low wall drag at 45° C. (curve F), the batch has a wall drag cliff at velocities between 0.25 in/s and 2 in/s for each of the other temperatures. The presence of the wall drag cliff at these temperatures indicates that the batch mixture will have high wall drag during at least some of the extrusion process, may require greater pressures for extrusion, and may yield an unfired extruded body that is distorted. Accordingly, in various embodiments, the extrusion process may be altered depending on the particular bath mixture so as to operate within a desired range.

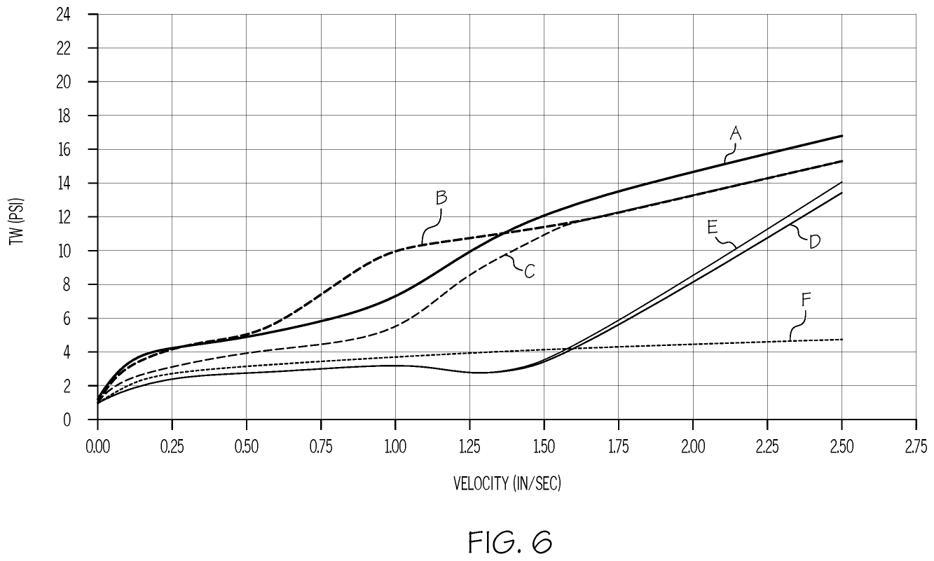

FIG. 6 is a plot of wall shear stress T_{w} as a function of the exit velocity v of the extrudate from a capillary die having a 1 mm diameter for a batch mixture having polyalphaolefin in a concentration of 5.5% and stearic acid in a concentration of 1.5% (sample 2). A comparison of FIG. 6 with FIG. 5 shows the effect of increasing the concentration of the non-polar carbon chain lubricant (e.g., polyalphaolefin) on the wall drag at various temperatures and velocities. In particular, the figures show that the increase in non-polar carbon chain lubricant shifts the wall drag cliff to the right for all temperatures tested.

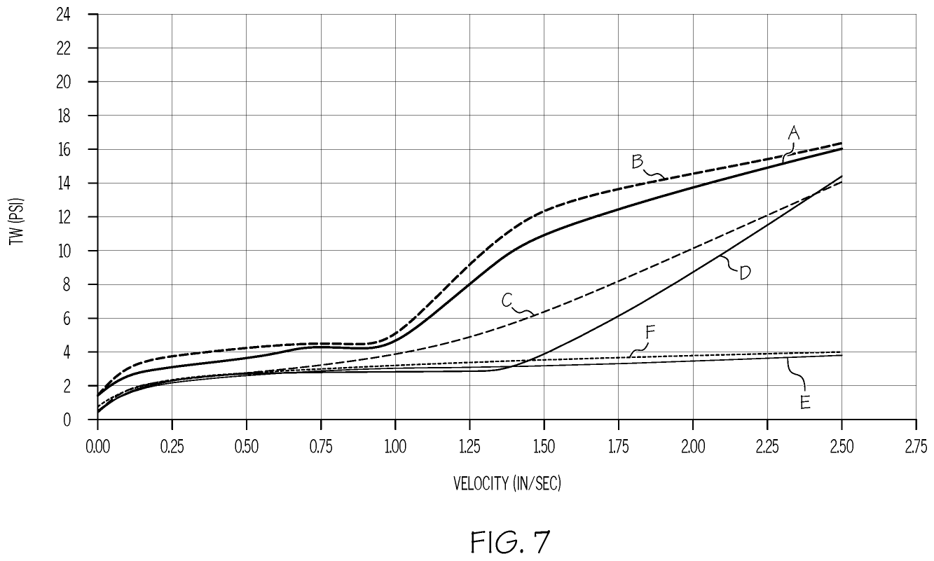

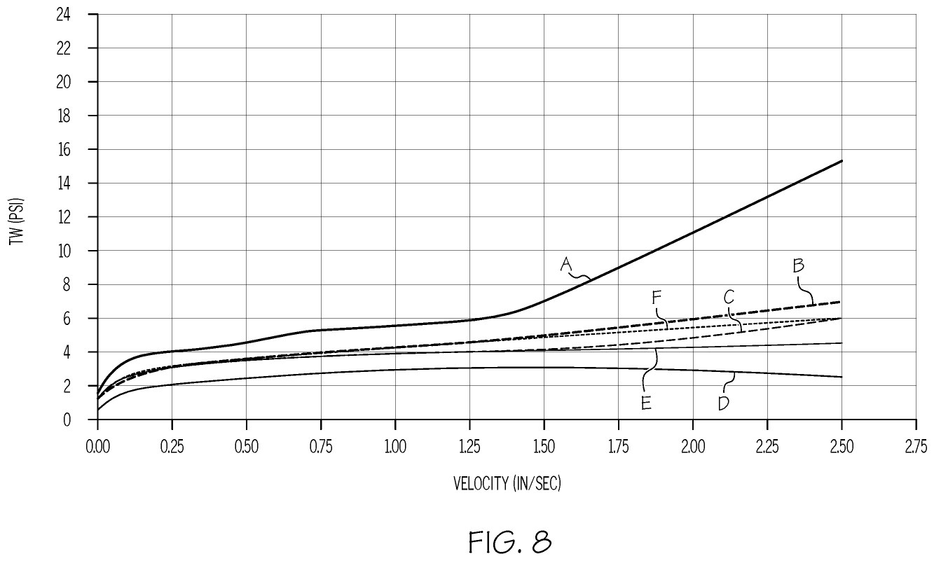

FIGS. 7 and 8 are plots of wall shear stress T_{w} as a function of the exit velocity v of the extrudate from a capillary die having a 1 mm diameter for batch mixtures having polyalphaolefin in a concentration of 4% and stearic acid at concentrations of 2% and 3%, respectively (samples 3 and 4, respectively). A comparison of FIGS. 5, 7, and 8 shows the effect of increasing the concentration of the organic surfactant (e.g., stearic acid) on the wall drag at various temperatures and velocities. In particular, the figures show that the increase in organic surfactant shifts the wall drag cliff to the right for all temperatures tested, and in the composition including 3% stearic acid, results in low wall drag at most of the temperatures over the range of velocities tested. Accordingly, the batch mixture of FIG. 8 may be most suitable of the batches having 4% polyalphaolefin for extrusion because of its low wall drag over the widest range of velocities and at the greatest number of temperatures.

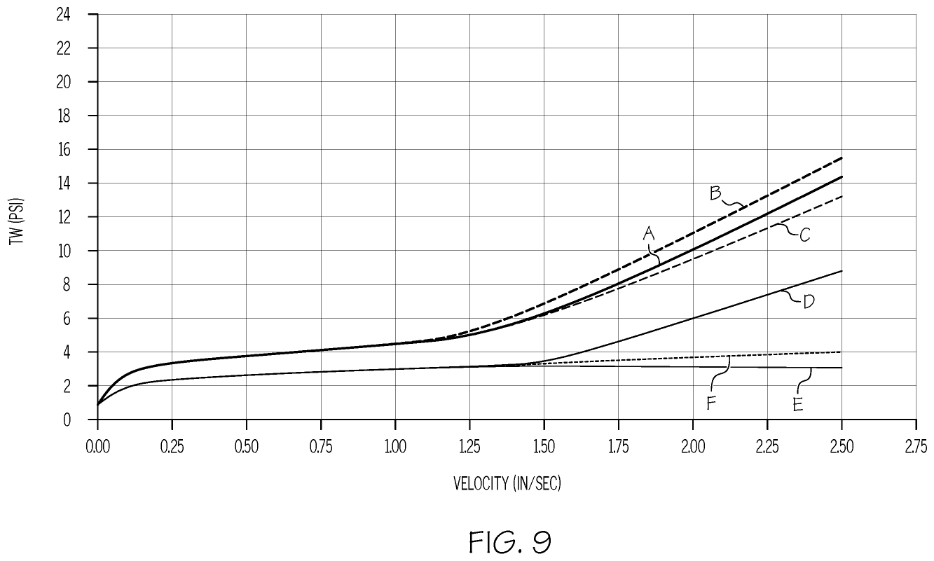

FIG. 9 is a plot of wall shear stress T_{w} as a function of the exit velocity v of the extrudate from a capillary die having a 1 mm diameter for a batch mixture having polyalphaolefin in a concentration of 4.75% and stearic acid in a concentration of 2% (sample 5). A comparison of FIG. 9 with FIG. 7 shows the combined effect of increasing the concentration of the non-polar carbon chain lubricant and organic surfactant, shifting the wall drag cliff further to the right than when only the concentration of the organic surfactant is increased. However, a comparison of FIG. 9 with FIG. 8 indicates that the batch mixture containing more stearic acid and less polyalphaolefin (e.g., the batch mixture of FIG. 8) would likely be preferred because of its low wall drag over the range of velocities at the greatest number of temperatures.

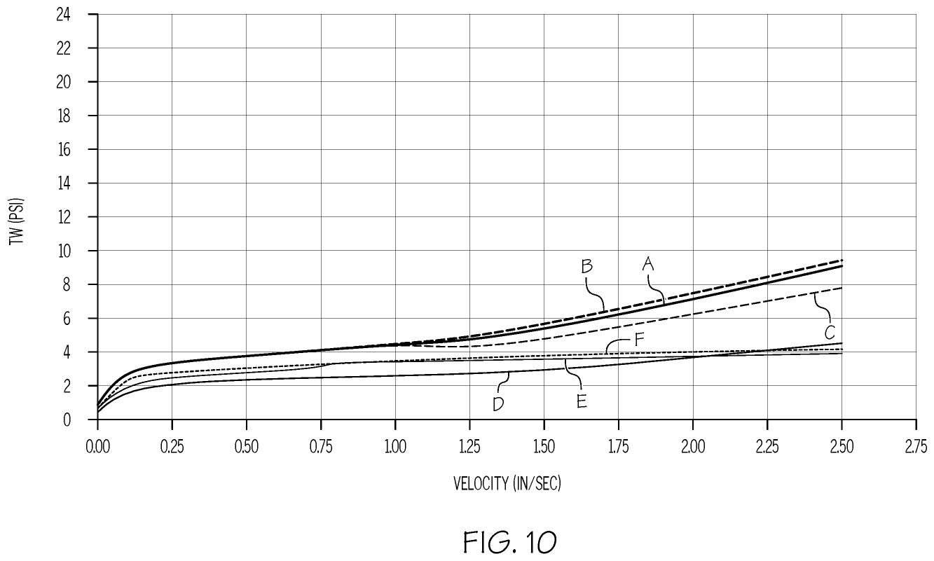

FIG. 10 is a plot of wall shear stress T_{w} as a function of the exit velocity v of the extrudate from a capillary die having a 1 mm diameter for a batch mixture having polyalphaolefin in a concentration of 5.5% and stearic acid in a concentration of 2% (sample 6). A comparison of FIG. 10 with FIGS. 7 and 9 further illustrates the impact of an increased concentration of polyalphaolefin. In particular, the increased concentration of polyalphaolefin results in lower wall drag over the range of velocities at all of the temperatures tested. Additionally, a comparison of FIG. 10 with FIG. 6 demonstrates the effect of an increased amount of stearic acid in combination with an increased amount of polyalphaolefin. More specifically, an increased amount of stearic acid in combination with an increased amount of polyalphaolefin results in low wall drag at most of the temperatures over the range of velocities tested, and a shift of the velocity cliff to the right.

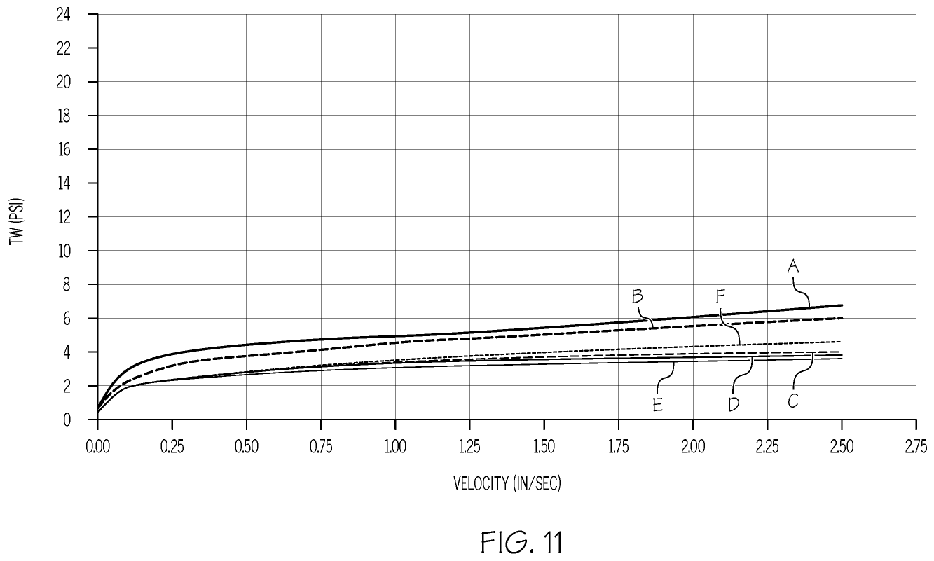

FIG. 11 is a plot of wall shear stress T_{w} as a function of the exit velocity v of the extrudate from a capillary die having a 1 mm diameter for a batch mixture having polyalphaolefin in a concentration of 5.5% and stearic acid in a concentration of 3% (sample 7). As shown in FIG. 11, the increased concentration of both the stearic acid and the polyalphaolefin results in a wall drag below about 6 psi for velocities between 0.01 in/s and 2.5 in/s at temperatures of 10° C., 17° C., 24° C., 31° C., 38° C., and 45° C. Because of the low wall drag over the complete range of velocities and temperatures tested, the batch mixture of FIG. 11 may be most suitable for various embodiments. Additionally, a comparison of FIG. 11 with FIG. 5 demonstrates the synergistic effect of increasing the concentrations of both the stearic acid and the polyalphaolefin to yield a batch mixture having low wall drag.

### Example 2

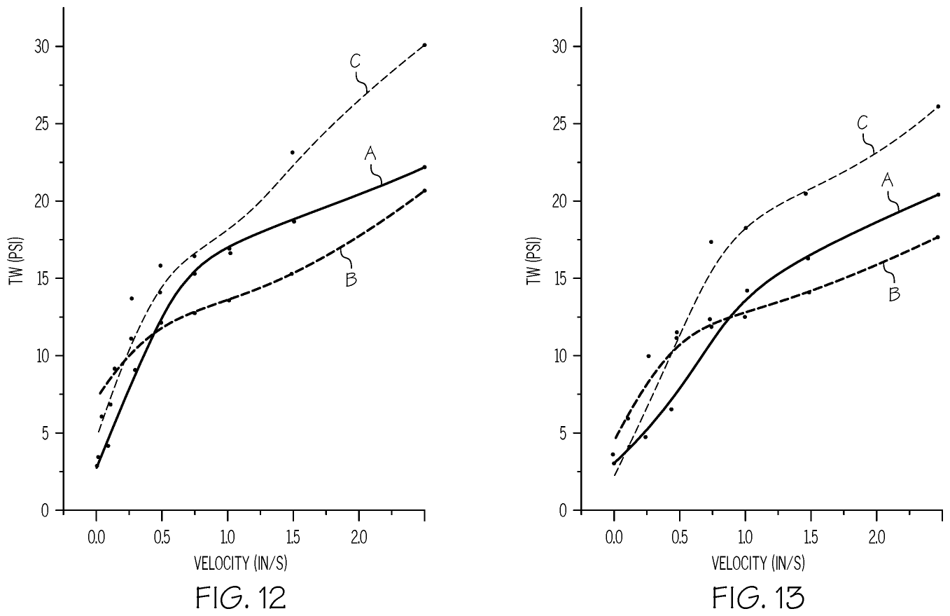

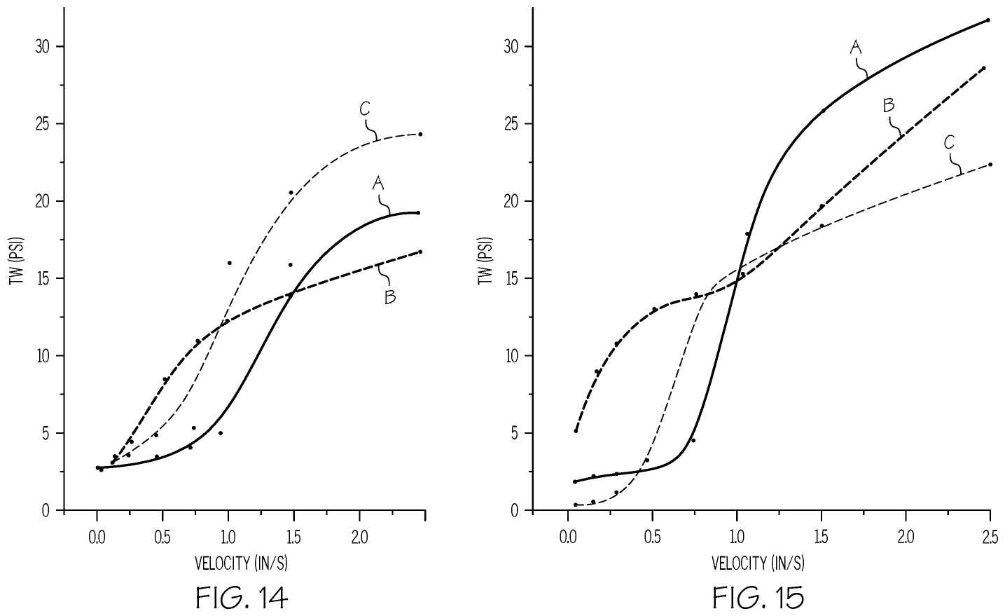

A series of three batches including stearic acid as an organic surfactant and including different non-polar carbon chain lubricants were prepared and tested using the sweep rate test described hereinabove. Each batch mixture included the same inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package. The organics package for each of the batch mixtures are summarized in Table 2. Wall shear stress was measured for velocities ranging from 0.01 in/s to 2.5 in/s and at temperatures of 10° C. (FIG. 12), 18° C. (FIG. 13), 26° C. (FIG. 14), for each batch mixture. The results of the sweep rate test are graphically depicted in FIGS. 12-14 as a plot of wall shear stress T_{w} as a function of the exit velocity v of the extrudate from a capillary die having a 1 mm diameter.

TABLE 2
Batch Compositions, expressed in wt %

| | Sample 8 | Sample 9 | Sample 10 |
|---|---|---|---|
| Stearic Acid | 0.7 | 0.7 | 0.7 |
| Polyalphaolefin | 6 | 0 | 0 |
| NEXBASE ® 3020 | 0 | 6 | 0 |
| PARAFLEX ™ HT5 | 0 | 0 | 6 |
| C₁ | 1 | 1 | 1 |
| C₂ | 2 | 2 | 2 |
| B | 1 | 1 | 1 |
| SC | 7.4 | 7.4 | 7.4 |

FIG. 12 is a plot of wall shear stress T_{w} as a function of the exit velocity v of the extrudate from a capillary die having a 1 mm diameter for batch mixtures having 0.7% stearic acid and 6% polyalphaolefin (represented by curve A; sample 8), 6% base oils commercially available under the trade name NEXBASE® 3020 (represented by curve B; sample 9), and 6% base oils commercially available under the trade name PARAFLEX™ HT5 (represented by curve C; sample 10) at 10° C. FIG. 13 is a plot of wall shear stress T_{w} as a function of the exit velocity v of the extrudate from a capillary die having a 1 mm diameter for batch mixtures having 0.7% stearic acid and 6% polyalphaolefin (represented by curve A; sample 8), 6% base oils commercially available under the trade name NEXBASE® 3020 (represented by curve B; sample 9), and 6% base oils commercially available under the trade name PARAFLEX™ HT5 (represented by curve C; sample 10) at 18° C. FIG. 14 is a plot of wall shear stress T_{w} as a function of the exit velocity v of the extrudate from a capillary die having a 1 mm diameter for batch mixtures having 0.7% stearic acid and 6% polyalphaolefin (represented by curve A; sample 8), 6% base oils commercially available under the trade name NEXBASE® 3020 (represented by curve B; sample 9), and 6% base oils commercially available under the trade name PARAFLEX™ HT5 (represented by curve C; sample 10) at 26° C.

As a comparison of FIGS. 12-14 shows, each of the non-polar carbon chain lubricants decreases the pressure of the system over time, confirming that non-polar carbon chain lubricants in addition to polyalphaolefins are suitable for various embodiments described herein.

### Example 3

A series of seven batch mixtures having 6% non-polar carbon chain lubricant and different organic surfactants were prepared and tested using the sweep rate test described hereinabove. Each batch mixture included the same inorganic components in the form of cordierite-forming raw materials having an overall composition comprising, in weight percent on an oxide basis, 5-25 wt % MgO, 40-60 wt % SiO₂, and 25-45 wt % Al₂O₃ and a varying organics package. The organics package for each of the batch mixtures are summarized in Table 3. For the batch mixtures, pressure was measured over velocities between 0.01 in/s and 2.5 in/s and at a variety of temperatures. FIG. 15 is a plot of wall shear stress T_{w} as a function of the exit velocity v of the extrudate from a capillary die having a 1 mm diameter for batch mixtures having 0.4% linoleic acid and 0.3% stearic acid (represented by curve A; sample 11), 0.7% soy lecithin (represented by curve B; sample 12), and 1.8% soy lecithin (represented by curve C; sample 13) at 18° C.

TABLE 3
Batch Compositions, Expressed in wt %

| | Sample 11 | Sample 12 | Sample 13 | Sample 14 | Sample 15 | Sample 16 | Sample 17 |
|---|---|---|---|---|---|---|---|
| Polyalphaolefin | 0 | 0 | 0 | 6 | 6 | 6 | 6 |
| NEXBASE ® | 6 | 6 | 6 | 0 | 0 | 0 | 0 |
| 3020 | | | | | | | |
| Stearic acid | 0.3 | 0 | 0 | 0 | 0 | 0 | 0.7 |
| Linoleic acid | 0.4 | 0 | 0 | 0 | 0 | 0 | 0 |
| Soy lecithin | 0 | 0.7 | 1.8 | 0 | 0 | 0 | 0 |
| Lauric acid | 0 | 0 | 0 | 0.7 | 0 | 0 | 0 |
| Myristic acid | 0 | 0 | 0 | 0 | 0.7 | 0 | 0 |
| Palmitic acid | 0 | 0 | 0 | 0 | 0 | 0.7 | 0 |
| C₁ | 1 | 1 | 1 | 1 | 1 | 1 | 1 |
| C₂ | 2 | 1.2 | 1.2 | 3.2 | 2.8 | 2.4 | 2 |
| B | 1 | 1 | 1 | 1 | 1 | 1 | 1 |
| SC | 7.4 | 6.84 | 8.16 | 7.925 | 7.75 | 7.575 | 7.4 |

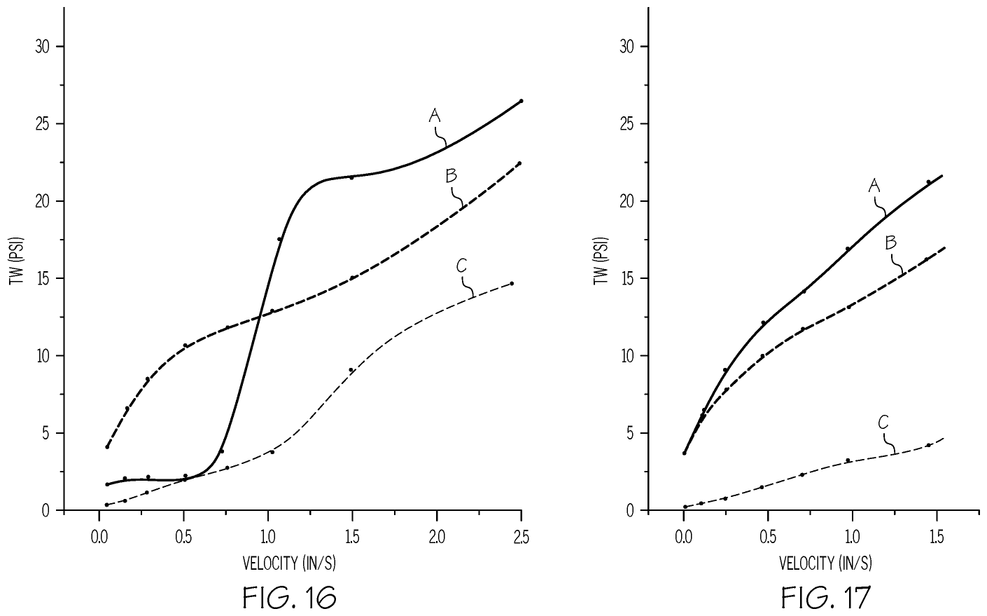

FIG. 16 is a plot of wall shear stress T_{w} as a function of the exit velocity v of the extrudate from a capillary die having a 1 mm diameter for batch mixtures having 0.4% linoleic acid and 0.3% stearic acid (represented by curve A; sample 11), 0.7% soy lecithin (represented by curve B; sample 12), and 1.8% soy lecithin (represented by curve C; sample 13) at 26° C. FIG. 17 is a plot of wall shear stress T_{w} as a function of the exit velocity v of the extrudate from a capillary die having a 1 mm diameter for batch mixtures having 0.4% linoleic acid and 0.3% stearic acid (represented by curve A; sample 11), 0.7% soy lecithin (represented by curve B; sample 12), and 1.8% soy lecithin (represented by curve C; sample 13) at 34° C. A comparison of FIGS. 15, 16, and 17 confirms that the increased temperature for each of the batch mixtures reduces the wall drag and shifts the velocity curve to the right, as in batch mixtures containing stearic acid alone.

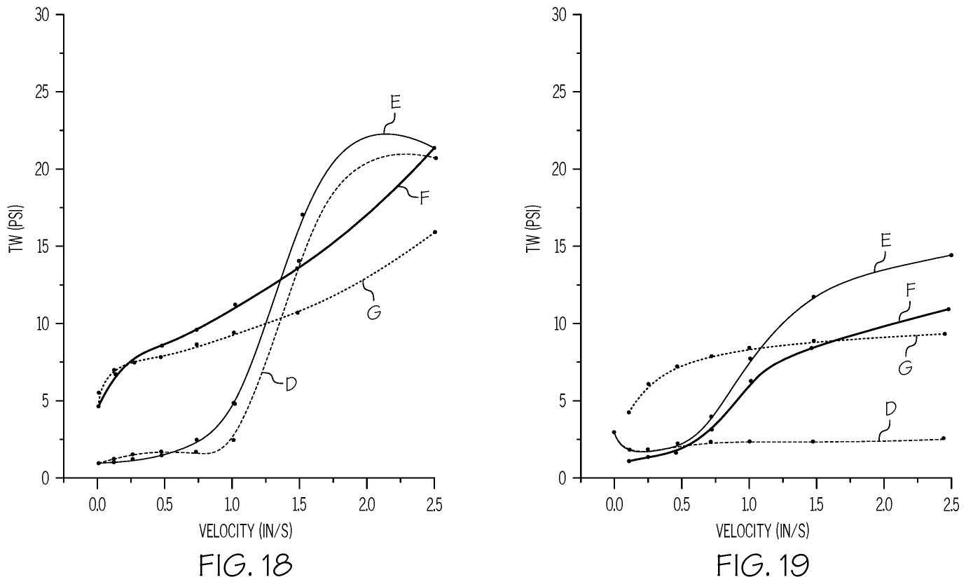

FIG. 18 is a plot of wall shear stress T_{w} as a function of the exit velocity v of the extrudate from a capillary die having a 1 mm diameter for batch mixtures having 0.7% lauric acid (represented by curve D; sample 14), 0.7% myristic acid (represented by curve E; sample 15), 0.7% palmitic acid (represented by curve F; sample 16), and 0.7% stearic acid (represented by curve G; sample 17) at 30° C. FIG. 19 is a plot of wall shear stress T_{w} as a function of the exit velocity v of the extrudate from a capillary die having a 1 mm diameter for batch mixtures having 0.7% lauric acid (represented by curve D), 0.7% myristic acid (represented by curve E), 0.7% palmitic acid (represented by curve F), and 0.7% stearic acid (represented by curve G) at 40° C. FIGS. 18 and 19 indicate that some organic surfactants may result in less wall drag than stearic acid at particular velocities and temperatures. The results illustrated in FIGS. 18 and 19 may be used, for example, to select a batch mixture for a specific velocity or temperature.

The data illustrates the suitability of various combinations of non-polar carbon chain lubricants and organic surfactants for use in accordance with one or more embodiments described herein. In particular, a range of both non-polar carbon chain lubricants and organic surfactants can be combined according to the relationship:

B[C₁(d+d₀)+C₂(f+f₀)]=SC,

where: d₀ is a minimum amount of the non-polar carbon chain lubricant in percent by weight of the inorganic component, by super addition; d is an additional amount of the non-polar carbon chain lubricant in percent by weight of the inorganic component, by super addition; f₀ is a minimum amount of the organic surfactant in percent by weight of the inorganic component, by super addition; f is an additional amount of the organic surfactant in percent by weight of the inorganic component, by super addition; C₁ is a scaling factor of the concentration of the non-polar carbon chain lubricant; C₂ is a scaling factor of the concentration of the organic surfactant; and B is a scaling factor based on other extrusion factors to yield a ceramic precursor batch having low wall drag for a particular velocity and temperature. The decreased wall drag can yield unfired extruded bodies having less shape distortion and tighter webs while decreasing production costs by reducing the pressure for extrusion (and, therefore, the energy put into the system) and extending die life.

It should now be understood that embodiments of the present disclosure enable the organics package for a ceramic precursor batch to be specifically selected to have low wall drag. The decreased wall drag can provide product and quality benefits, process benefits, and reductions in manufacturing and cost. For example, the ability to alter the wall drag for a ceramic precursor batch may minimize bow and reduce slump, while increasing die life and reducing energy costs. Moreover, various embodiments enable the batch mixture to be modified such that it has the same wall drag independent of dies or other machines employed in the process. Other advantages will be appreciated by one skilled in the art.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of manufacturing a honeycomb structure comprising extruding a batch mixture through an extrusion die at one or more extrusion velocities and at one or more temperatures, the batch mixture being comprised of one or more inorganic components comprising one or more ceramic or ceramic-forming ingredients, a non-polar carbon chain lubricant, and an organic surfactant,
wherein the non-polar carbon chain lubricant and the organic surfactant are present in concentrations satisfying the relationship:
B[C1(d+3)+C2(f+0.3)]=SC,
where:
d is an added amount over a minimum of 3 wt % of the non-polar carbon chain lubricant, in percent by weight of the inorganic component, by super addition, wherein 3≤(d+3)≤10;
f is an added amount over a minimum of 0.3 wt % of the organic surfactant, in percent by weight of the inorganic component, by super addition, wherein 1≤(f+0.3)≤10;
0.5≤C1≤1.5;
0.5C1≤C2≤4C1;
0.4≤B≤2; and
3.6≤SC≤14.

2. The method of claim 1 wherein during the extruding the batch mixture has a wall drag of less than about 10 psi during the extruding.

3. The method of claim 2 wherein the wall drag is less than about 8 psi.

4. The method of claim 2 wherein the wall drag is less than about 6 psi.

5. The method of claim 2 wherein the wall drag is less than about 4 psi.

6. The method of claim 1 wherein during the extruding the batch mixture has a wall shear stress of less than about 10 psi over a range of velocities from about 0.1 in/s to about 2.5 in/s at temperatures between about 10° C. and about 45° C.

7. The method of claim 1 wherein during the extruding the batch mixture has a wall shear stress of less than about 8 psi over a range of velocities from about 0.1 in/s to about 2.5 in/s at temperatures between about 24° C. and about 45° C.

8. The method of claim 1 wherein during the extruding the batch mixture has a wall shear stress of less than about 6 psi over a range of velocities from about 0.1 in/s to about 2.5 in/s at temperatures between about 31° C. and about 45° C.

9. The method of claim 1 wherein during the extruding the batch mixture has a wall shear stress of less than about 6 psi over a range of velocities from about 0.1 in/s to about 2.5 in/s at temperatures between about 24° C. and about 45° C.

10. The method of claim 1 wherein during the extruding the batch mixture has a wall shear stress of less than about 4 psi over a range of velocities from about 0.1 in/s to about 2.5 in/s at temperatures between about 24° C. and about 45° C.

11. The method of claim 1 wherein the organic surfactant comprises a fatty acid.

12. The method of claim 1 wherein the organic surfactant comprises stearic acid, oleic acid, tall oil, linoleic acid, lauric acid, myristic acid, palmitic acid, palmitoleic acid, soy lecithin, or combinations thereof.

13. The method of claim 1 wherein the organic surfactant comprises C₈-C₂₂ fatty acids and/or their ester or alcohol derivatives, or combinations thereof.

14. The method of claim 1 wherein the organic surfactant is present in an amount of at least 0.3 wt % of the inorganic components, by super addition.

15. The method of claim 1 wherein the organic surfactant has a polar head.

16. The method of claim 1 wherein the non-polar carbon chain lubricant is a mineral oil.
